(19) United States
(12) Patent Application Publication
(10) Pub. No.: US 2009/0266267 A1
(43) Pub. Date: Oct. 29, 2009

(54) SYSTEM FOR TOWER- AND CABLE-BASED TRANSPORTATION STRUCTURE

(76) Inventor: Alan D. Moss, El Cajon, CA (US)

Correspondence Address: THE MAXHAM FIRM, 9330 SCRANTON ROAD, SUITE 350, SAN DIEGO, CA, 92121, US

(21) Appl. No.: 12/433,796

(22) Filed: Apr. 30, 2009

Related U.S. Application Data
(63) Continuation of application No. PCT/US2007/083232, filed on Oct. 31, 2007.
(60) Provisional application No. 60/863,944, filed on Nov. 1, 2006.

(51) Int. Cl. B61B 7/00; A63G 31/00; F03G 7/00

(52) U.S. Cl. 104/53; 104/113; 290/1 R

(57) ABSTRACT

A system of one or more tower structures operationally configured for cable-based transportation, including adaptations of such technologies that may blend into surrounding environments, and which are particularly beneficial for use in connection with amusement facilities.

### FIELD OF INVENTION

The present application relates generally to the field of towers and cable-based transportation, and more particularly to adaptations of such technologies for use in connection with amusement facilities.

### BACKGROUND OF THE INVENTION

Towers are tall structures that are used for a variety purposes. These purposes generally take advantage of a tower's characteristic height. For example, uses may include observation, recreation, communication and a variety of other uses. Towers come in variety of structural designs, and generally are readily identifiable as towers.

Cables are frequently used to hoist or secure objects, often above ground. They may also be used to transport goods or people in conjunction with a pulley or other similar system. Using such a pulley or other similar system, in combination with elevation and gravity as a propelling force, objects or people may be secured to such a cable and transported from one point to another across the cable line.

People have created such elevated transportation cable lines by affixing cables to highly elevated points in naturally growing or planted trees. These transportation cables are sometimes used for recreational purposes. Users of the transportation cables (“zip lines”) experience the exhilaration of traveling across the cable lines and also experience the observational vantage point of being high in the trees or tree canopy. With the rise in “eco-tourism,” rainforest and adventure tours have increased the popularity of such activities.

Unfortunately, the task of attaching cable lines to naturally growing or planted trees is fraught with difficulties which include, but are not limited to aesthetics, practicality, the environment, and safety. Many locations where such tree based cable transportation systems have been implemented or are desirable are aesthetically and environmentally delicate. For example, rainforests that are prized for their undisturbed growth may be affected by attaching cables to trees. It is undesirable in many respects to harm the environment by fashioning cable-based transportation systems in naturally growing trees.

Furthermore, safety issues exist for consumers when natural trees are used for cable transportation systems. Trees may experience excessive weight loads or restricted growth because of tight cables. Also, trees are continually growing organisms, and their suitability for weight bearing uses is unpredictable. For example, a tree's weight bearing capacity may be affected by unusual growth patterns or unstable root systems. Also, a tree's suitability for load bearing may change due to disease or other changed environmental factors. In addition, users of the natural tree cable-based systems face unpredictable and varying surfaces or structures that may be difficult to navigate safely. These problems are further compounded in instances where large numbers of people are likely to use such structures, for instance, in amusement park settings or in heavily visited natural parks.

There are other practical considerations that make the current practice of fashioning cable transportation systems in natural trees undesirable. Namely, the type of tree that grows in a particular geographical location limits the creation of such cable transportation systems. Some locations may not support the growth of trees at all, while in other locations, the type of tree that may be grown cannot physically or otherwise support such an endeavor. This is particularly the case in an amusement park setting where a particular ride theme requires the look and appearance of a particular variety of foliage. Additionally, natural trees are susceptible to deterioration, winds, lightning, fire, soil erosion and other acts of nature.

A man-made tower and cable-based transportation structure is needed that visually blends with its surrounding environment, or created environment, and that allows safe, cable-based transportation in aesthetically and environmentally diverse locations.

### SUMMARY OF THE INVENTION

Accordingly, it is a purpose of the present invention to provide a tower that is aesthetically harmonious with surrounding objects and may be configured to mimic the appearance of trees.

It is another purpose of the present invention to provide a tower and cable-based transportation system having structures that are aesthetically harmonious with surrounding objects. These structures include cable-based configurations that mimic the appearance of trees, yet which are sturdy and particularly suited for use in connection with recreational and amusement environments.

Other purposes of the invention will become apparent to those skilled in the art once the various invention embodiments have been shown and described. These purposes are not to be construed as limitations of the invention, but are merely aimed to suggest some of the many benefits that may be realized by the apparatus of the present invention and with its many embodiments.

### BRIEF DESCRIPTION OF THE DRAWING

The manner in which these objectives and other desirable characteristics can be obtained is explained in the following detailed description and attached drawing, in which:

FIG. 1 is a perspective view of a tower- and cable-based transportation system, with towers fashioned to resemble trees.

FIG. 2 is a perspective view featuring an alternate embodiment of the tower- and cable-based transportation system featuring towers of an industrial construction and appearance, but which are used in conjunction with a similar cable-based transportation structure;

FIG. 3 is a top view of a platform embodiment with a landing platform and gates for entering and exiting the platform via cable, wherein the landing platform provides a safe landing area and the gates provide an extra measure of security and safety for users and is intended to be employed in either the FIG. 1 or the FIG. 2 embodiments;

FIG. 4A is an elevational view of an alternative platform embodiment and, more particularly, of an alternative means of affixing the platform to a tower structure, with a segment of a tower being shown to which the platform is mounted;

FIG. 4B is a plan view of an alternative placement for the landing platform in relation to the platform and for placement for the gate;

FIG. 5 is a partial side view of an embodiment of a landing platform suitably angled downward in relation to the platform to aid the user in landing at the platform;

FIG. 6 is a perspective view of another embodiment of a tower- and cable-based transportation system particularly useful in connection with entertainment travel; and

FIG. 7 is a perspective view of yet another embodiment of the present tower- and cable-based transportation system.

### DETAILED DESCRIPTION OF THE PREFERRED EMBODIMENTS

It is to be noted that the appended drawing figures illustrate only typical embodiments of this invention and are therefore not to be considered limiting of its scope, for the invention may admit to other equally affective embodiments that will be appreciated by those reasonably skilled in the relevant technical field. Also, drawings are not necessarily made to scale but are representative only.

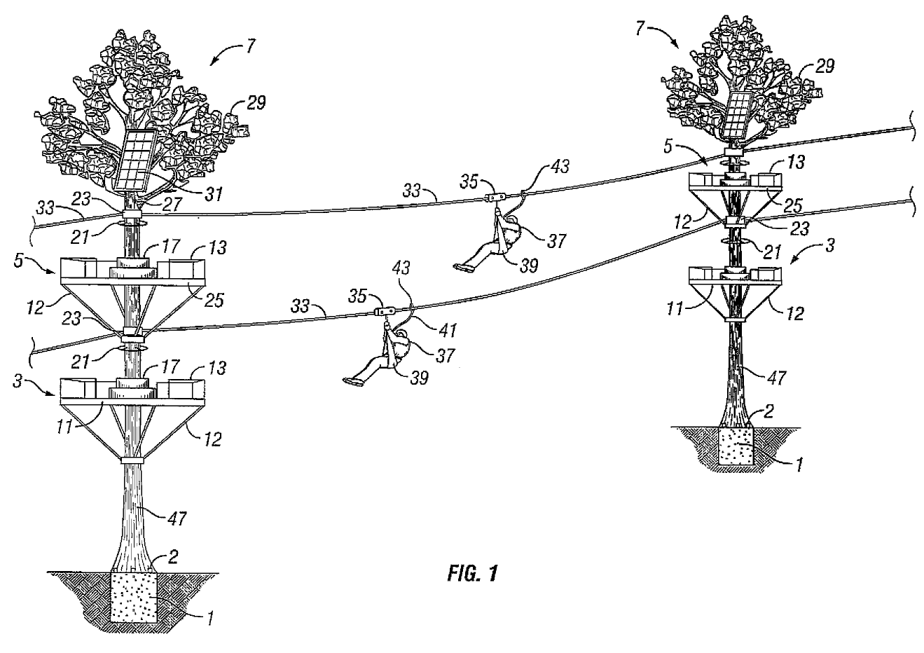

FIG. 1 depicts an embodiment of a preferred tower and cable-based transportation structure in accordance with the invention. Basic components of the tower- and cable-based transportation structure comprise supports 1, towers 7, lower tower module 3, upper tower module 5, platforms 11 and 25, cable 33, and pulleys 35. Support 1 is suitably fashioned from any number of materials including, but not limited to, concrete, steel, rebar, among others, and which are engineered in a structurally stable manner dictated by the soil, terrain, or other conditions of the location. Supports 1 employ technologies known in the construction industry for the securing of foundations of buildings or towers. Tower 7 may be of unitary fabrication or modular as further described herein. The base of lower tower module 3 is suitably affixed to support 1 using footings 2 or other known and appropriate affixing means, such as, but not limited to, welding, bonding, or interlocking apparatus. Lower tower module 3 may be fashioned from any rigid material such as any variety of metal, alloys, plastic, wood, or other compounds having these qualities. Upper tower module 5 is affixed to the top end of the lower tower module (if construction is modular) using appropriate affixing means, such as, but not limited to, bolts, welding, bonding, or interlocking apparatus. The upper tower module may be fashioned from any rigid material such as any variety of metal, alloy, plastic, wood, or other compound having these qualities. The lower tower module and upper tower module connect (where modular components are used) and serve a primary function of bearing weight load. The tower may be operationally configured not only to withstand a particular weight, but also to have desired capacity to bend, flex, or withstand other physical forces. Alternately, the upper and lower tower modules may be formed of one uniform pole. Such a pole, and the underlying support of tower 7, may take the form of a tower as is typically constructed to support cellular phone antennae.

In connection with erection of towers, a soil investigation is suitably conducted by a geotechnical engineering firm for each tower site to determine its unique soil and physical characteristics, and to provide data to develop safe design parameters, economical foundation alternatives and installation procedures. Once engineering has been completed, cement footings are usually poured for each tower location. When the curing time has passed for each support, a tower base (lower tower module 3) is typically lowered onto the cement footings, usually by means of a crane. Towers are suitably secured to the cement footing (support 1) with large anchor bolts, or other suitable apparatus (footings 2) known in the industry, with the gauge of such bolts varying by desired tree height (ranging from 10 to 200 feet), lateral loads, and local engineering requirements. Cranes are also suitably used to install second modular components of the tower as well as fabricated treetops, which may or may not include foliage 29.

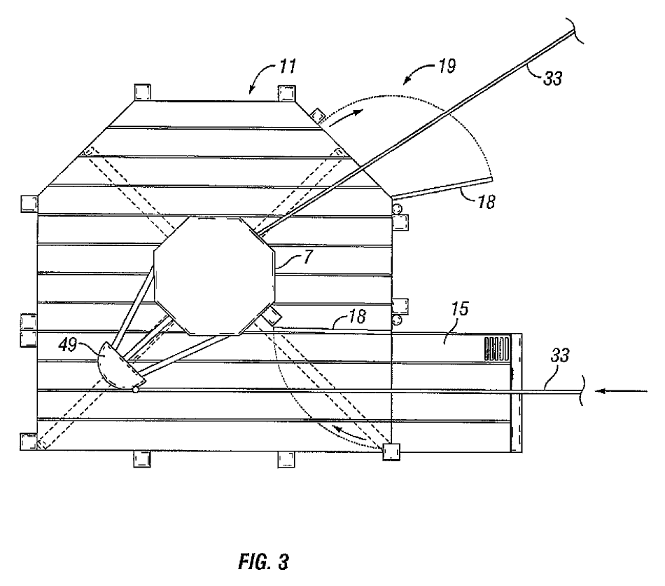

FIG. 1 also shows a suitable arrangement of a lower platform 11 and an upper platform 25 coupled to tower 7. Lower platform 11 may be affixed to lower tower module 3 using appropriate affixing means, such as, but not limited to, bolts, welding, bonding, or interlocking apparatus. Supporting beams 12 may be affixed to lower tower module 3 and to the bottom edge or other location of lower platform 11. Railing 13 may surround the entire outer edge of the lower platform, excepting temporary or permanently removed sections to facilitate landing and departure of users or objects, or both, via cable 33. Landing platform 15 (FIG. 3) may extend outwardly from lower platform 11 and may be affixed permanently or temporarily to the desirable location on the outer edge of the lower platform by a variety of affixing means including, but not limited to, bolts, welding, bonding, hinges, or interlocking apparatus. Platforms (11 and 25) are specifically configured to handle weight loads anticipated by users. The platforms described in the present application may be specifically engineered to withstand very specific safety standards and be maintained to the satisfaction of park operators.

Surrounding tower 7 in a circular configuration, is a step 17 which may be suitably affixed to either or both the tower 7 and lower platform 11 by using appropriate affixing means, such as, but not limited to, bolts, welding, bonding, or interlocking apparatus. Step 17 is shown as having two levels. This is to accommodate smaller users to enable them to have a footing when arriving at the tower terminus of a ride segment in cases where their legs may be insufficiently long to enable their feet to engage the platform. It also provides a seat for riders if they want to pause between rides.

FIG. 1 further shows a preferable positioning of safety fastener receiver or ring 21 above step 17 at an appropriate height wherein users may connect safety fasteners 43. The safety fastener receiver may be made of any appropriately sturdy material, including, but not limited to, metal or other compounds, and may be affixed to tower 7 using appropriate affixing means, such as, but not limited to, bolts, welding, bonding, or interlocking apparatus. FIG. 1 also shows a suitable positioning of cable fasteners 23 to tower 7 using appropriate affixing means, such as, but not limited to, bolts, welding, or bonding. With the predictable artificial structure described herein, safety fastener receiver 21 may be placed so that it is completely unobstructed by undesired branches or the like.

As a rider arrives at platform 11, 25, safety fastener 43 is unhooked from cable 33 and hooked onto safety ring 21. Then the user removes pulley 35 from cable 33, walks around to the outgoing cable 33 and, when ready to ride the next segment to another tower, hooks safety fastener 43 onto the outgoing cable, and then pulley 35 onto that cable.

Still referring to FIG. 1, a preferably suitable arrangement of upper platform 25 on tower 7 is depicted. Upper platform 25 serves the same general functions as lower platform 11, with the benefit of being able to accommodate a substantial number of additional riders on the same set of towers. The upper platform may be affixed to upper tower module 5 using appropriate affixing means, such as, but not limited to, bolts, welding, bonding, or interlocking apparatus. As with lower platform 11, supporting beams 12 may be affixed to upper tower module 5 and to the bottom edge or other location of the upper platform 25. Railing 13 may surround the entire outer edge of upper platform 25, excepting temporary or permanently removed sections to facilitate landing and departure of users or objects, or both, via cable 33.

Landing platform 15 (FIG. 3) may extend outwardly from upper platform 25 and may be affixed permanently or temporarily to the desirable location on the outer edge of the upper platform by a variety of affixing means including, but not limited to, bolts, welding, bonding, hinges, or interlocking apparatus. Such landing platforms 15 lend to ease of arrival to or departure from a particular tower.

Surrounding tower 7 in a circular configuration is step 17 which may be affixed to either or both tower 7 and upper platform 25 by using appropriate affixing means, such as, but not limited to, bolts, welding, bonding, or interlocking affixing apparatus.

Further, FIG. 1 shows a preferable positioning of safety fastener receiver 21 above steps 17 at an appropriate height wherein users may connect safety fasteners 43. Safety fastener receiver 21 may be made of any appropriately sturdy material, such as, but not limited to, metal or other compounds, and may be affixed to tower 7 using appropriate affixing means, such as, but not limited to, bolts, welding, or bonding. Also shown is a preferable positioning of cable fasteners 23 to tower 7 using appropriate affixing means, such as, but not limited to, bolts, welding, or bonding.

The cables 33 of the present invention serve a primary function of supporting the weight of a plurality of users 37 and pulleys 35, so a variety of materials may be preferable, including but not limited to, wound steel of the variety found on ski lifts, composite materials, and polymeric fibers of notable strength and durability, among others. Those skilled in the industry will appreciate appropriate materials for use as cable 33.

FIG. 1 additionally shows a preferable positioning of a solar panel 31 on tower 7. Solar panels may be used as a power source for a variety of electrically powered devices and to power outlets that may be positioned at desirable locations on the tower- and cable-based transportation structure. In addition to keeping with the environmentally conscientious intent of this invention, solar panels can facilitate the communications and electrically dependent support apparatus for the ride.

A particular benefit of embodiments of the present application are that a tower may be configured to receive artificial foliage of any variety, whether deciduous, coniferous, tropical, or any other variety. Thus, a park in the desert may be adapted to a “tropical” theme, if the park operator so desires. Toward this end, FIG. 1 shows a preferable positioning of foliage receivers 27 and foliage 29. Foliage receivers 27, such as branches, are affixed at any desirable locations on the tower by using appropriate affixing means, such as, but not limited to, bolts, welding, bonding, or interlocking apparatus. The foliage receivers are operationally configured to receive foliage 29. Foliage 29, of the users preferred style, is inserted into foliage receivers 27 and secured using appropriate affixing means, such as but not limited to bolts, welding, bonding, or any other interlocking apparatus. Foliage 29 consists of branches, leaves, needles, or other appropriate forms fabricated out of man-made or natural materials including but not limited to wood, metal, plastic, rubber, vinyl, silk, artificial silk, and latex, or any other materials or compounds capable of imitating natural foliage. When skillfully placed, the foliage will ideally give the user of the attraction the look and feel of being close to real trees. Moreover, the artificial tree may be constructed among real forests and trees, thus giving the user a feel and proximity to nature, while simultaneously avoiding unnecessary stresses to the natural elements.

With further reference to FIG. 1, there is depicted bark 47 as applied to the exterior surface of tower 7. The bark 47 is fabricated out of man-made or natural materials, including but not limited to, wood, metal, plastic, polyurethane, rubber, vinyl, latex, or other materials or compounds that may simulate the natural bark of a tree. Bark 47 is affixed to tower 7 using appropriate affixing means, such as but not limited to bolts, screws, nails, chemical adhesives, welding, or bonding.

In addition, FIG. 1 shows a user 37 in the act of traveling along cable 33 between two towers, employing cable-based transportation structures such as harness 39, pulley 35, safety cable 41 and safety fastener 43. Harness 39 may be configured to support people or other objects, or both, to be transported between tower- and cable-based transportation structures or a tower- and cable-based transportation structure and other cable 33 receiving structure. Attached to harness 39 is pulley 35 or similar device that may be attached to or used in conjunction with cable 33 in order to enable transportation along the cable. Safety cable 41 may be additionally connected to cable 33 with a safety fastener 43 to further insure safety for the user or object traveling along cable 33. Such a safety fastener 43 may feature a carabiner securing apparatus. The harness 39 is preferably of a conventional variety that will be appreciated by those skilled in the mountaineering and climbing arts.

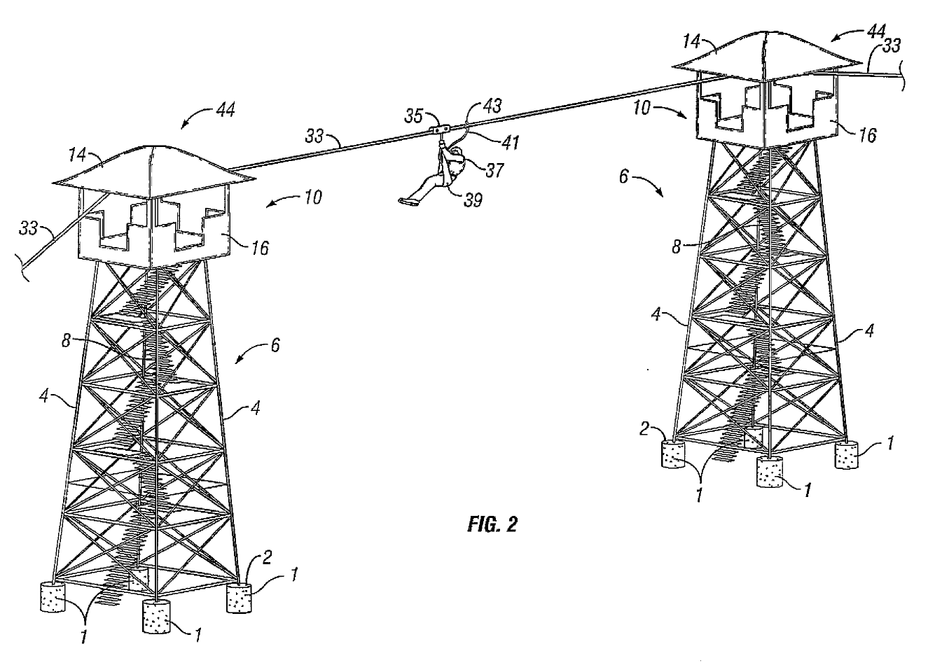

FIG. 2 depicts an alternate embodiment of a system involving a tower- and cable-based transportation structure. The alternate embodiment depicts a suitable structure fashioned to aesthetically blend with an urban, militaristic, or other closely related environment as may be desirable in a theme park, amusement park, or other setting. A preferable use is that a plurality of supports 1 are fashioned from any number of materials including, but not limited to, concrete, and engineered in a structurally stable manner dictated by the soil, terrain, or other conditions of the location. The bases of a suitable plurality of legs 4 are affixed to the supports using footings 2 or other appropriate affixing means, such as, but not limited to, welding, bonding, or interlocking apparatus. The legs may be interconnected by lattice framework 6 or other reinforcing apparatus to form towers 44. A suitable plurality of legs 4 and lattice framework 6, or other reinforcing apparatus, may be fashioned from any rigid material such as any variety of metal, plastic, wood, or other compounds having these qualities. Staircase 8 (or elevator) or other similar structure may be used to provide access to the upper areas of the transportation structure. The staircase or other similar structure may be affixed to legs 4 or to other load bearing structure.

FIG. 2 also depicts an alternate embodiment of a preferable tower- and cable-based transportation system with the inclusion of a shelter 10 affixed to tower 44. Shelter 10 includes a roof 14 and permanent or removable full or half-height walls 16. The passenger or goods carrying apparatus shown in FIG. 2 is substantially the same as in FIG. 1.

FIG. 3 is a plan view of platform 11, including landing platform 15, and gates 18 for entering and exiting the platform via a cable 33. Platform 25 may be substantially the same shape and structure as platform 1, or it may have a different size and shape. It functions in a similar manner. Landing platform 15 provides a safe landing area for users and the gates 18 provide an extra measure of security and safety for users. This embodiment of the tower- and cable-based transportation system of the invention includes cable support 49 which offsets the positioning and direction of cable 33 used for entry. Offsetting the cable for entry allows for a larger landing area for the user and directs the user away from the center of the tower, enhancing the safety of the landing. Cable 33 may be affixed directly to cable support 49 using appropriate affixing means, such as, but not limited to, bolts, welding, or bonding. Alternatively, cable support 49 may route the direction and positioning of cable 33 by means of a pulley system, rounded edge, or other means, so that the cable may be threaded through the outer end of support 49 and then directed toward cable fastener 23, which affixes the cable to tower 7. It is contemplated that each cable 33 has its end secured to cable fastener 23 at tower 7, requiring the user to land on and stop at each platform. In an alternative arrangement, a user may be able to ride continuously past each tower, using known technology for mounting cables to towers and known pulley configurations. It will also be appreciated by those skilled in the art that the landing platform is shown as polygonal, but it could be made of a variety of shapes surrounding the circumference of the tower.

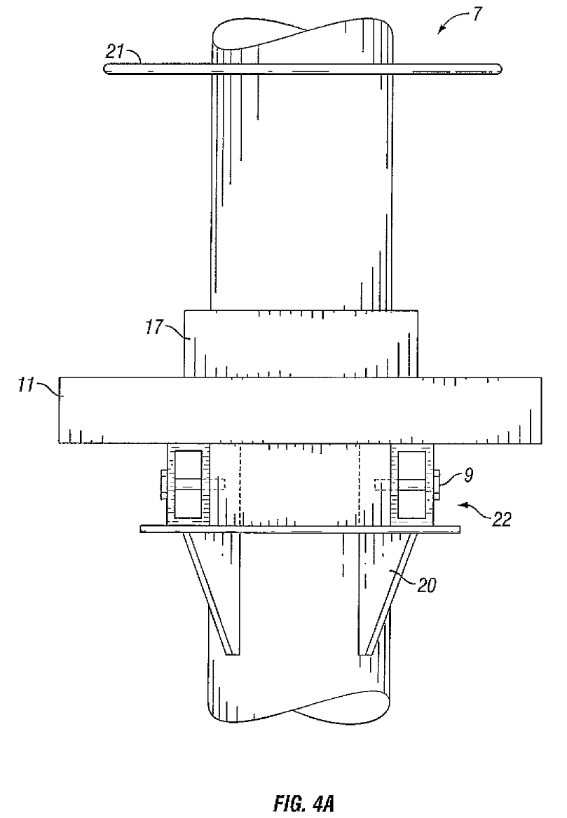

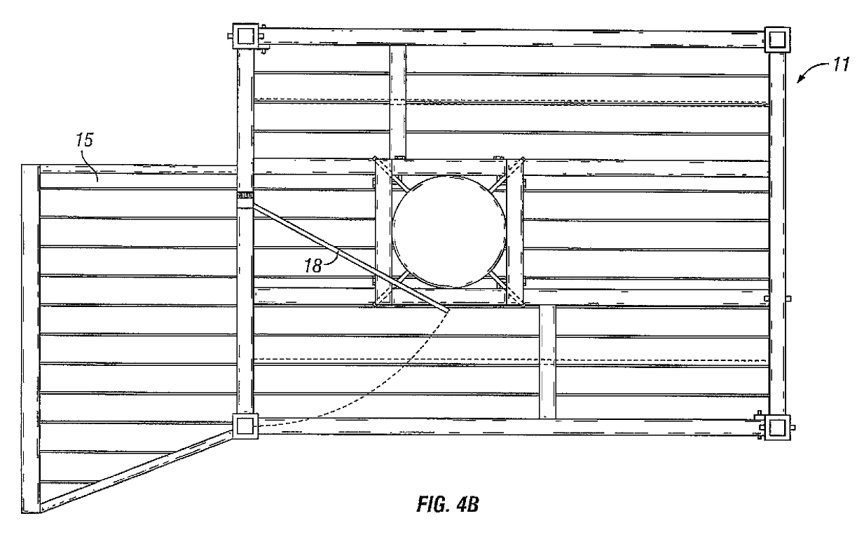

FIG. 4A is an elevational view of platform 11, and more particularly, of an alternative means of affixing the platform to the tower 7 structure. The platform is supported and rests upon platform tube frame 22, located directly beneath platform 11. The platform may be affixed to the platform tube frame using appropriate affixing means, such as but not limited to bolts, welding, bonding, or any other interlocking apparatus. Platform tube frame 22 is affixed, in part, to the tower structure by means of bolts 9. The platform tube frame is further affixed to the tower structure by supporting gussets 20 that have been affixed to tower 7 by appropriate means such as, but not limited to, bolts, welding, bonding, or any other interlocking apparatus.

FIG. 4B depicts an alternative shape for platform 11 and an alternative placement for landing platform 15 in relation to platform 11. FIG. 4B also depicts an alternative placement for gate 18.

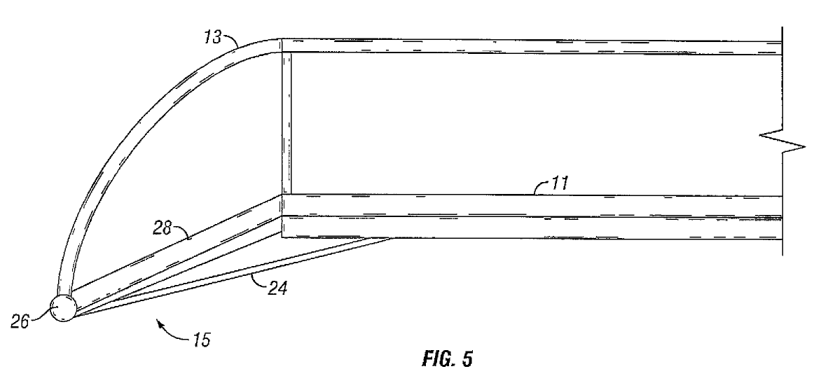

FIG. 5 is a side view of an exemplary embodiment of landing platform 15. This landing platform is suitably angled downward in relation to platform 11. Landing platform 15 aids the user in landing by providing an optimal angle of approach, suitable sloped landing area 28, curved safety railing 13, and optimal surface texture to prevent slippage upon landing. Landing platform 15 may be affixed to the outer edge of platform 11 using appropriate affixing means such as, but not limited to, bolts, welding, bonding, or any other interlocking apparatus. Landing platform 15 is further strengthened and supported by means of brace 24, which is affixed to the platform. The surface of landing area 28 may be modified to provide a textured surface to reduce or eliminate slippage by the user. This may be accomplished by a variety of means including but not limited to texturizing of the landing area with primary building material, texturized adhesive tapes, carpeting, rubber, chemical compounds, or other such means. To provide a measure of safety, the outer bottom edge of landing area 28 may consist of a safety bumper 26 which may be fabricated from natural or man made material including but not limited to rubber, plastic, vinyl, latex, or other compounds or materials that may provide a cushioning effect. Railing 13 of the landing platform is depicted to be curved in order to provide optimal safety and usability for the user, but other shapes could be used.

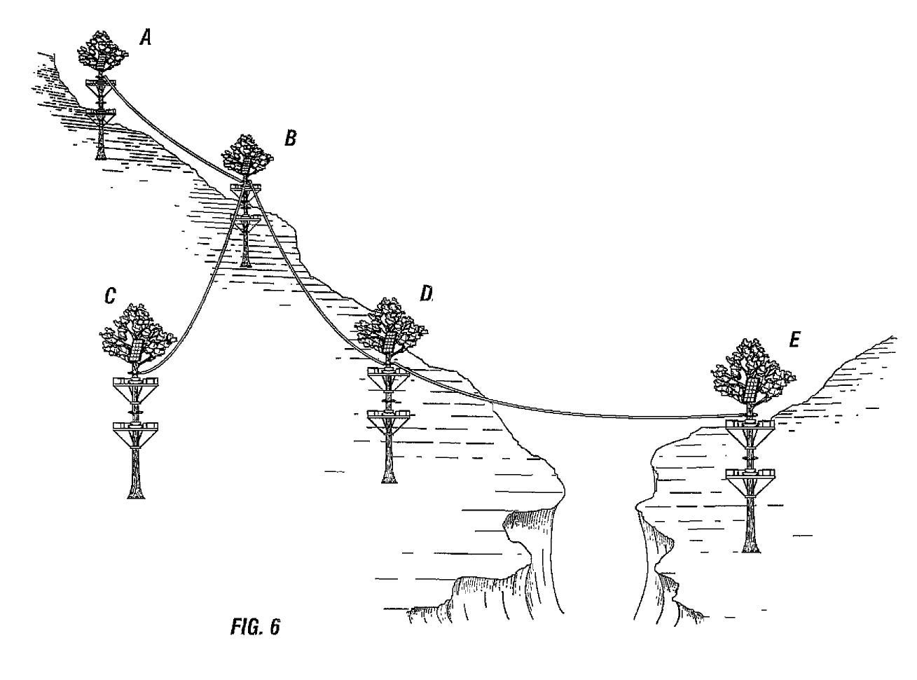

FIG. 6 is an alternative or expanded embodiment of a preferable tower- and cable-based transportation system particularly useful in connection with entertainment travel. Specifically, a plurality of tower structures are depicted that form a transportation network when operationally linked by cable apparatus. By employing such a network of interconnected towers, ride users may descend rapidly from one tower structure to the next, with each direction presenting a range of amusement possibilities. For instance, a rider might travel from tower “A” to tower “B,” and thereafter make a choice to travel to tower “C,” or perhaps to tower “D” and where the journey to tower “E” is particularly exhilarating, by way of either speed or scenery. The embodiment shown in FIG. 6 presents a “choose-your-own-adventure” theme ride with a variety of possibilities established by the ride designers. For instance, the journey between tower D and E might take a rider over a crevasse or cliff structure. The range of distance of a particular cable above ground can vary from one foot to thousands of feet. As with FIGS. 1 and 2, the embodiment disclosed in FIG. 6 is operationally configured to work with a pulley and gravity serving to accelerate the user from one location to the next. Acceleration and the corresponding “intensity” of a given ride, or ride-segment, is primarily determined by the ride designers who configure the ideal angles of descent between departure and arrival points, factoring prospective user weight, pulley resistance, friction coefficients, and length of travel The departure and arrival locations on varying towers preferably range from 50 to 2000 feet, although shorter or longer distances may be employed.

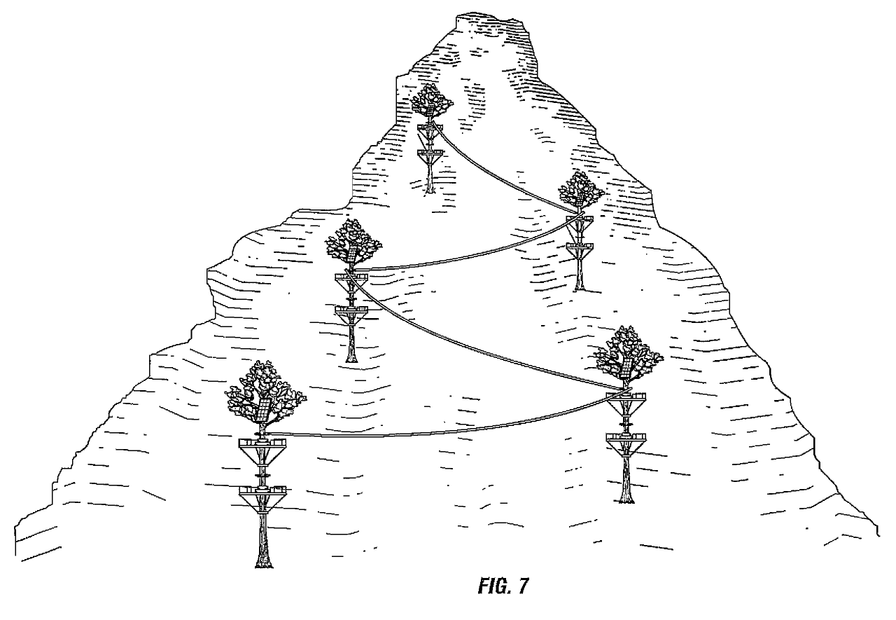

FIG. 7 is yet another alternative or expanded embodiment of the present tower- and cable-based transportation invention, wherein towers are positioned so that a user may descend above and along a mountain road, ski-run, or any other path determined by the ride designers. Such an adaptation of the present invention is particularly desirable at existing mountain resorts where ski lifts are already positioned to deliver riders to an elevated position on a mountain where they can easily enjoy a “zip-line” ride down the mountain face. This ride may be particularly beneficial for persons with physical disabilities who may be physically limited or incapable of descending a mountain on skis or other such devices, but who are nevertheless capable of sitting in a harness and experiencing the exhilaration of nature on a zip line.

It is to be noted, however, that the appended drawing illustrates only typical embodiments of this invention, are not to scale, and are therefore not to be considered limiting of its scope, for the invention may admit to other equally affective embodiments which are appreciated by those skilled in the art.

What is claimed is:

1. An aerial transport system comprising:
at least one tower;
at least one platform situated on said tower, wherein said platform is capable of supporting human activity thereon;
at least one corresponding location away from said platform;
at least one load bearing cable suspended between said tower and said corresponding location;
a harness apparatus; and
a means for using gravity to transport said harness along said cable.

2. The aerial transport system of claim 1, wherein said corresponding location features a landing.

3. The aerial transport system of claim 2, wherein said corresponding location is a second platform situated on a second tower, wherein said second platform is capable of supporting human activity thereon.

4. The aerial transport system of claim 3, wherein said landing extends distally from said second platform thereby facilitating the arrival of said harness.

5. The aerial transport system of claim 1, wherein said tower is aesthetically harmonious with surrounding objects.

6. The aerial transport system of claim 1, wherein said tower resembles an organism of the plantea kingdom.

7. The aerial transport system of claim 1, wherein said tower resembles a tree.

8. The aerial transport system of claim 1, wherein said tower is a pole.

9. The aerial transport system of claim 8, wherein said pole is segmented.

10. An aerial transport system comprising:
a series of man made towers;
at least one platform vertically situated on each of said towers in said series, wherein each of said platforms is capable of supporting human activity thereon;
at least one load bearing cable that suspends between at least two of said platforms in said series;
a harness apparatus; and
a means for using gravity to transport said harness from one of said towers to another of said towers along said series.

11. The aerial transport system of claim 10, wherein at least one of said platforms features a landing.

12. The aerial transport system of claim 11, wherein said landing extends distally from said second platform thereby facilitating the arrival of said harness.

13. The aerial transport system of claim 12, wherein a portion of said landing is angled downward in relation to said platform.

14. The aerial transport system of claim 10, wherein at least one of said towers in said series is aesthetically harmonious with surrounding objects.

15. The aerial transport system of claim 10, wherein at least one of said towers in said series resembles an organism of the plantea kingdom.

16. The aerial transport system of claim 10, wherein at least one of said towers in said series mimics a tree.

17. The aerial transport system of claim 10, wherein said tower is a pole.

18. The aerial transport system of claim 17, wherein said pole is segmented.

19. The aerial transport system of claim 10, and further comprising:
a means for generating electricity; and
means for delivering electricity to various locations in the system.

20. A method of entertaining humans comprising:
erecting a series of man made vertical load bearing structures or towers that resemble an organism of the plantea kingdom;
situating at least one platform on each of said towers in said series, wherein each of said platform is capable of supporting human activity thereon;
suspending at least one load bearing cable between at least two of said towers in said series;
securing a harness apparatus to a human;
securing said harness apparatus to a means for using gravity to transport said harness secured to said human from one of said towers to another of said towers along said series; and
transporting said human between at least two of said towers.
